(19) United States
(12) Patent Application Publication
(10) Pub. No.: US 2019/0309402 A1
(43) Pub. Date: Oct. 10, 2019

(54) ALUMINUM ALLOY PRODUCTS HAVING FINE EUTECTIC-TYPE STRUCTURES, AND METHODS FOR MAKING THE SAME

(71) Applicant: ARCONIC INC., Pittsburgh, PA (US)

(72) Inventors: Lynette M. Karabin, Ruffs Dale, PA (US); David W. Heard, Pittsburgh, PA (US); Zhi Tang, Pittsburgh, PA (US); Yijia Gu, Pittsburgh, PA (US); Men Glenn Chu, Export, PA (US); Jen C. Lin, Export, PA (US); Andreas Kulovits, Pittsburgh, PA (US)

(21) Appl. No.: 16/444,804

(22) Filed: Jun. 18, 2019

Related U.S. Application Data
(63) Continuation of application No. PCT/US2017/067979, filed on Dec. 21, 2017.
(60) Provisional application No. 62/437,542, filed on Dec. 21, 2016.
(60) Provisional application No. 62/558,231, filed on Sep. 13, 2017.

(51) Int. Cl. C22F 1/04; B33Y 10/00; B33Y 40/00; C22C 21/00; B23K 26/00; B23K 26/342; B23K 26/70

(52) U.S. Cl. CPC C22F 1/04; B33Y 10/00; B33Y 40/00; B23K 2103/10; B23K 26/0006; B23K 26/342; B23K 26/703; C22C 21/00

(57) ABSTRACT

The present disclosure relates to various embodiments of aluminum alloy products having fine eutectic-type structures and methods for making the same. The method for producing an aluminum alloy product having a fine eutectic-type structure comprising selectively heating at least a portion of an additive manufacturing feedstock to a temperature above a liquidus temperature of the additive manufacturing feedstock, thereby forming a molten pool; and cooling the molten pool, thereby forming a solidified mass.

### CROSS-REFERENCE TO RELATED APPLICATIONS

This application is a continuation of International Patent Application No. PCT/US2017/067979, filed Dec. 21, 2017, which claims the benefit of priority of U.S. Provisional Patent Application No. 62/437,542, filed Dec. 21, 2016, and claims the benefit of priority of U.S. Provisional Patent Application No. 62/558,231, filed Sep. 17, 2017, each of which is incorporated herein by reference in its entirety.

### FIELD OF THE INVENTION

This patent application relates to aluminum alloy products having fine eutectic-type structures, and methods for making the same.

### BACKGROUND

The Aluminum Association Global Advisory Group defines “aluminum alloys” as “aluminum which contains alloying elements, where aluminum predominates by mass over each of the other elements and where the aluminum content is not greater than 99.00%.” (Global Advisory Group GAG—Guidance, GAG Guidance Document 001, Terms and Definitions, Edition 2009-01, March 2009, § 2.2.2.) An “alloying element” is a “metallic or non-metallic element which is controlled within specific upper and lower limits for the purpose of giving the aluminum alloy certain special properties” (§ 2.2.3). A casting alloy is defined as “alloy primarily intended for the production of castings,” (§ 2.2.5) and a “wrought alloy” is “alloy primarily intended for the production of wrought products by hot and/or cold working” (§ 2.2.5).

### SUMMARY OF THE DISCLOSURE

Broadly, the present patent application relates to new aluminum alloy products, and methods for making the same. Due to the unique compositions and/or manufacturing processes described herein, the new aluminum alloy products may realize, for instance, one or more specifically designed, tailored properties of the resulting product and/or preferential regions having tailored properties within the aluminum alloy products (e.g. differing properties tailored at certain locations of a product). Examples of tailored properties include, but are not limited to: (a) fine eutectic-type microstructures, and/or (b) a high volume fraction of discrete intermetallic particles.

In one approach, and referring now to FIG. 1, the new aluminum alloy products may be produced via additive manufacturing. As used herein, “additive manufacturing” means “a process of joining materials to make objects from 3D model data, usually layer upon layer, as opposed to subtractive manufacturing methodologies”, as defined in ASTM F2792-12a entitled “Standard Terminology for Additively Manufacturing Technologies”. In one embodiment, a method of making an additively manufactured body includes the steps of: (a) selectively heating (200) at least a portion of an additive manufacturing feedstock (e.g., via a laser) to a temperature above the liquidus temperature of the particular body to be formed, thereby forming a molten pool, and (b) cooling (300) the molten pool thereby forming a solidified mass, the solidified mass having a fine eutectic-type structure. In another embodiment, a method of making an additively manufactured body includes the steps of: (a) dispersing (100) an additive manufacturing feedstock (e.g., a metal powder) in a bed (or other suitable container), the additive manufacturing feedstock comprising a sufficient amount of aluminum, alloying elements, and optional additions to produce an aluminum alloy having a fine eutectic-type structure, (b) selectively heating (200) at least a portion of the additive manufacturing feedstock (e.g., via an energy source or laser) to a temperature above the liquidus temperature of the particular body to be formed, thereby forming a molten pool, and (c) cooling (300) the molten pool thereby forming a solidified mass, the solidified mass having a fine eutectic-type structure. In one embodiment, the cooling comprises cooling at a rate of at least 1000° C. per second. In another embodiment, the cooling rate is at least 10,000° C. per second. In yet another embodiment, the cooling rate is at least 100,000° C. per second. In another embodiment, the cooling rate is at least 1,000,000° C. per second. Steps (a)-(c) may be repeated as necessary until the body is completed, i.e., until the final additively manufactured body is formed/completed. The final additively manufactured body also generally comprises a fine eutectic-type structure.

The additive manufacturing feedstock(s) used to create the final additively manufactured body may be of any of the compositions given below. In some embodiments, the additive manufacturing feedstock is a powder. In this aspect, the additive manufacturing powder feedstock may be comprised of any combination of metallic powders, alloy powders, and non-metallic powders (e.g., ceramic powders; intermetallic powders). Furthermore, an additive manufacturing feedstock powder may comprise metallic powders and/or alloy powders, where the particles comprising the metallic powders and/or alloy particles have additions therein (e.g., ceramic materials, among others). In one embodiment, the additive manufacturing feedstock comprises aluminum and at least one other alloying element. In another embodiment, the additive manufacturing feedstock comprises at least one addition. In another embodiment, the additive manufacturing feedstock comprises at least one grain refiner. In some embodiments, the grain refiner comprises at least one ceramic material. In some embodiments, the additive manufacturing feedstock is an alloy powder comprised of alloy particles, wherein the alloy particles themselves have non-metallic particles therein. By way of non-limiting example, an additive manufacturing feedstock powder may be comprised of alloy particles, and the alloy particles may include a plurality of non-metallic particles or additions therein, wherein the non-metallic particles or additions have a smaller size than the alloy particles therein.

For powder additive manufacturing feedstocks, the powder itself may comprise a fine eutectic-type structure, among other characteristics. In this regard, the feedstock itself may realize any of the characteristics of the aluminum alloy products described herein (e.g. one or more of the described characteristics including: equiaxed grains, an average grain size, volume percentage of discrete intermetallic particles, cell size of the cellular structures, spacing between eutectic structures, among others). For instance, the feedstock may comprise equiaxed grains, an average grain size of not greater than 20 microns (i.e., micrometers), up to 35 vol. % discrete intermetallic particles, cellular structures having a cell size of not greater than 1 micron, spacing between eutectic structures of not greater than 1 micron, among others. In this aspect of the present invention, the powders may be produced via any suitable method. In one embodiment, the powder is produced via a process having rapid solidification of the powder. In some embodiments, the aluminum alloy powder is produced via a method having a sufficient solidification rate to facilitate production of the fine eutectic-type structure. In this regard, the aluminum alloy powder may be produced via any one of plasma atomization, gas atomization, or impingement of a molten aluminum alloy (e.g., solidification of an impinging molten metal droplet on a cold substrate). In some embodiments, the powder is configured for use in an additive manufacturing process.

While the present disclosure generally relates to aluminum alloy products produced via powder-based additive manufacturing methods, in some embodiments, one or more of the below aluminum alloy compositions may also find utility in wire-based additive manufacturing methods. For instance, wire-based additive manufacturing methods that utilize an electron beam and/or plasma arc may be used.

As used herein, “fine eutectic-type structure” means a eutectic-type microstructure, generally having cellular, lamellar, and/or wavy structures within individual grains. In some embodiments, a eutectic-type structure comprises cellular structures having a cell size of generally less than 1 micron, and/or a spacing of less than 1 micron between lamellar structures and/or wavy structures. In other embodiments, the cell size is not greater than 0.5 micron. In some embodiments, the cell size is not greater than 0.4 micron. In some embodiments, the cell size is not greater than 0.3 micron. In some embodiments, the cell size is at least 10 nanometers (0.01 micron). In some embodiments, the spacing between lamellar structures and/or wavy structures is not greater than 0.5 micron. In some embodiments, the spacing between lamellar structures and/or wavy structures is not greater than 0.4 microns. In some embodiments, the spacing between lamellar structures and/or wavy structures is not greater than 0.3 microns. In some embodiments, the spacing between lamellar structures and/or wavy structures is at least than 10 nanometers (0.01 micron).

As used herein, a “cell” is a secondary dendrite. During solidification, a eutectic-type structure comprising cellular structures may form in a manner where primary dendrites form first, followed by the formation of secondary dendrites that originate from a primary dendrite.

In some embodiments, the cell walls, lamellar and/or wavy structures comprise intermetallic compounds, and these intermetallic compounds may make up to 35 vol. % of the final additively manufactured body. In some embodiments, the cell walls, lamellar and/or wavy structures comprise intermetallic compounds, wherein the intermetallic compounds make up to 30 vol. % of the final additively manufactured body. In some embodiments, the intermetallic compounds make up to 25 vol. % of the final additively manufactured body. In some the intermetallic compounds make up at least 5 vol. % of the final additively manufactured body. In some embodiments, the intermetallic compounds make up at least 10 vol. % of the final additively manufactured body. In some embodiments, the intermetallic compounds make up at least 15 vol. % of the final additively manufactured body. In some embodiments, the intermetallic compounds make up at least 20 vol. % of the final additively manufactured body. In some embodiments, the intermetallic compounds make up 15-35 vol. % of the final additively manufactured body. In some embodiments, the intermetallic compounds make up 20-30 vol. % of the final additively manufactured body. These fine eutectic-type structures may facilitate production of final products having a large volume fraction of discrete dispersoids therein (e.g., having 15-35 vol. % discrete intermetallic particles). In some embodiments, the discrete dispersoids are realized in the final additively manufactured body after a thermal treatment or thermomechanical treatment, as described in further detail below.

In some embodiments, he discrete intermetallic particles may generally realize an average particle size of not greater than 1 micron. In one embodiment, an aluminum alloy product realizes an average particle size of not greater than 0.8 micron. In another embodiment, an aluminum alloy product realizes an average particle size of not greater than 0.6 micron. In yet another embodiment, an aluminum alloy product realizes an average particle size of not greater than 0.4 micron. In another embodiment, an aluminum alloy product realizes an average particle size of not greater than 0.2 micron. In yet another embodiment, an aluminum alloy product realizes an average particle size of not greater than 0.1 micron (100 nm). In another embodiment, an aluminum alloy product realizes an average particle size of not greater than 0.01 micron (10 nm).

In some embodiments, “particle size” is the mean sectional diameter as determined by analyzing two-dimensional image micrographs. Particle size can be measured via a scanning electron microscope (SEM) operating in backscattered electron imaging (BEI) mode or via a Transmission Electron Microscope (TEM).

In another aspect of the invention, the aluminum alloy products described herein generally have a non-equilibrium freezing range of not greater than 680° F. In this regard, a narrow non-equilibrium freezing range (e.g., ≤680° F.) may facilitate production of tailored additively manufactured products (e.g., crack-free additively manufactured products). In one embodiment, an aluminum alloy product has a non-equilibrium freezing range of not greater than 650° F. In another embodiment, an aluminum alloy product has a non-equilibrium freezing range of not greater than 600° F. In yet another embodiment, an aluminum alloy product has a non-equilibrium freezing range of not greater than 500° F. In another embodiment, an aluminum alloy product has a non-equilibrium freezing range of not greater than 450° F. In yet another embodiment, an aluminum alloy product has a non-equilibrium freezing range of not greater than 400° F. In another embodiment, an aluminum alloy product has a non-equilibrium freezing range of not greater than 350° F. In yet another embodiment, an aluminum alloy product has a non-equilibrium freezing range of not greater than 300° F. In another embodiment, an aluminum alloy product has a non-equilibrium freezing range of not greater than 250° F. In yet another embodiment, an aluminum alloy product has a non-equilibrium freezing range of not greater than 200° F. In another embodiment, an aluminum alloy product has a non-equilibrium freezing range of not greater than 150° F. In yet another embodiment, an aluminum alloy product has a non-equilibrium freezing range of not greater than 100° F. In another embodiment, an aluminum alloy product has a non-equilibrium freezing range of not greater than 50° F. In yet another embodiment, an aluminum alloy product has a non-equilibrium freezing range of not greater than 25° F. In one embodiment, the aluminum alloy products or powders are configured to have a non-equilibrium freezing range of not greater than 400° F. and 15-35 vol. % discrete intermetallic particles therein. In another embodiment, the aluminum alloy products or powders are configured to have a non-equilibrium freezing range of not greater than 200° F. and 15-35 vol. % discrete intermetallic particles therein.

As used herein, “Non-equilibrium freezing range” means the solidification range calculated using Scheil solidification model implemented in commercial software PANDAT®. The Scheil solidification range is the non-equilibrium freezing range (complete diffusion in the liquid; no diffusion in the solid).

As one example, and referring now to FIG. 2, a micrograph of an additively manufactured Al—Ni—Mn alloy (5.3 wt. % Ni, 1.3 wt. % Mn) is shown. The additively manufactured Al—Ni—Mn alloy includes various eutectic structures, including microcellular (20), lamellar (22) and wavy (24) structures. The cell walls, lamella and/or wavy structures generally consist of intermetallic phases (e.g., Al₃Ni, Al₁₂Mn, Al₆Mn, and/or other Al—Ni—Mn compounds) dispersed in an aluminum solid solution phase (30). The aluminum phase may be a supersaturated solid solution. Other eutectic structures may be realized. For instance, any combination of microcellular (20), lamellar (22), and wavy (24) structures may be realized.

Referring now to FIGS. 1 and 3, after its production, the final additively manufactured product may optionally be thermally treated (400) at one or more temperatures and at one or more times. In some embodiments, the final additively manufactured body is thermally treated at a temperature sufficient and for a time sufficient to stress relieve the final additively manufactured body. In some embodiments, the final additively manufactured body is thermally treated at a temperature sufficient and for a time sufficient to produce discrete particles (40) therein. In the case of stress relief operations, the elevated temperature may be sufficiently low such that stress relief is imparted to the product, but the fine eutectic-type structure is maintained. In the case of production of discrete particles (40) via thermally treating (400), the discrete particles (40) may be formed from the cell walls of the microcellular structure and/or the lamella or wavy structures of the fine eutectic-type structure.

While not being bound by any particular theory, the discrete particles (40) are generally intermetallic phases dispersed in an aluminum matrix. For instance, the discrete intermetallic particles may be located within the aluminum alloy grains and/or located at grain boundaries. In one embodiment, a thermally processed aluminum alloy product generally comprises from 15-35 vol. % of discrete particles. In another embodiment, a thermally processed aluminum alloy product comprises 20-30 vol. % of discrete particles. These discrete particles may facilitate strength retention at elevated temperatures (e.g., in engine applications, such as for a turbo charge compressor impeller). In this regard, the micrograph shown in FIG. 3 was taken after exposure of the product to a temperature of about 600° F. for about 100 hours. As shown, the additively manufactured product comprises a plurality of discrete intermetallic particles (40). In some embodiments, an aluminum alloy realizes an amount of discrete particles sufficient to facilitate strength retention at elevated temperatures without thermal treatment. In some embodiments, an aluminum alloy realizes an amount of discrete particles sufficient to facilitate strength retention at elevated temperatures with thermal treatment. In this regard, the thermal treatment (400) conditions may be sufficient to realize discrete particle formation. Furthermore, the thermal treatment (400) conditions may result in generally spherical particles. For instance, the thermal treatment may facilitate spheroidization of intermetallic particles (e.g., cell wall intermetallic particles and/or lamella intermetallic particles). In this regard, the thermal treatment conditions (e.g., the time and temperature) sufficient to realize the discrete particle vary by alloy composition. However, in some embodiments the temperatures are at least several hundred degrees Fahrenheit. In some embodiments, the temperatures are greater than several hundred degrees Fahrenheit (e.g., the thermal treatment temperature is around 500-600° F., or higher). In this regard, the time(s) may be correspondingly adjusted based on the temperature(s) utilized.

The aluminum alloy product may optionally be worked (500) into a final worked product. In those embodiments where thermally treating (400) is employed, the working (500) may occur before, after or during (e.g., concomitant to) the thermally treating (400). The working may include hot working and/or cold working. The working (500) may include working all or a portion of the product. The working (500) may include, for instance, rolling, extruding, forging, and other known methods of working aluminum alloy products. In one embodiment, the working (500) comprises die forging the final additively manufactured product into the final worked product, wherein the final worked product is a complex shape (e.g., having a plurality of non-planar surfaces). In another embodiment, the working (500) comprises hot isostatic pressing (HIP) of the final additively manufactured product into a final HIP product.

As noted above, the new aluminum alloy products may be produced via additive manufacturing, and all additive manufacturing processes and apparatus defined in ASTM F2792-12a may be used to produce the new aluminum alloy products having the fine eutectic-type structure. As one example, selective laser sintering and/or binder jetting may be used, where the additive manufacturing feedstock powder itself has a fine-eutectic type structure. This powder may be dispersed in a bed, and selective laser sintering may be employed and/or a binder may be selectively jetted onto the powder. This process may be repeated, as appropriate, until a green additively manufactured part is completed, after which the green additively manufactured part may be further processed, such as by sintering and/or HIP'ing (hot isostatic pressing), thereby producing a final additively manufactured product. Since the additive manufacturing feedstock powder itself has the fine-eutectic type structure, the final additively manufactured product comprises the fine eutectic-type structure. After this final additively manufactured product is completed, it may be subjected to the thermal treatment (400) and/or working (500) steps, described above.

As another specific example, directed energy deposition may be used, where one or more additive manufacturing feedstock powders are sprayed in a controlled environment, and concomitant to the spraying, a laser is used to melt and/or solidify the sprayed additive manufacturing feedstock powder(s). This spraying and concomitant energy deposition may be repeated, as necessary to facilitate production of a final additively manufactured product having the fine eutectic-type structure. After this final additively manufactured product is completed, it may be subjected to the thermal treatment (400) and/or working (500) steps, described above.

### Compositions

The aluminum alloy compositions used to produce the fine eutectic-type microstructures may be any suitable binary, ternary, quaternary, or higher order aluminum alloy having the appropriate composition to facilitate production of the fine eutectic-type microstructures. In one approach, the aluminum alloy is an Al—Ni—Mn alloy, the aluminum alloy comprising at least nickel and manganese as alloying elements. In one embodiment, the aluminum, nickel, and manganese contents are controlled such that the alloy contains 0.5 to 15.5 wt. % Ni, 0.5 to 5.0 wt. % Mn, the balance being aluminum, optional additions, and unavoidable impurities, where Ni≥−2.75Mn+7.375, and where Ni≤−3.44Mn+17.22 (the values of Ni and Mn being in wt. %). Such requirements may facilitate production of Al—Ni—Mn alloy products having the fine eutectic-type structure. Intermetallic phases included in these products may include one or more of Al₆Mn, Al₁₂Mn, and Al₃Ni, among others.

In another approach, the aluminum alloy is an Al—Cu—Ni alloy, the aluminum alloy comprising at least copper and nickel as alloying elements. In one embodiment, the aluminum, copper, and nickel contents are controlled such that the alloy contains 1.0 to 22.0 wt. % Cu, 1.0 to 16.0 wt. % Ni, the balance being aluminum, optional additions, and unavoidable impurities, where Ni≥−0.78Cu+8.78, and where Ni≤−0.738Cu+17.24 (the values of Cu and Ni being in wt. %). Such requirements may facilitate production of Al—Cu—Ni alloy products having the fine eutectic-type structure. Intermetallic phases included in these products may include one or more of Al₂Cu, Al₇Cu₄Ni, and Al₃Ni, among others. In a particular embodiment, the aluminum, copper, and nickel contents are controlled such that the alloy contains 1.0 to 22.0 wt. % Cu, 1.0 to 16.0 wt. % Ni, the balance being aluminum, optional additions, and unavoidable impurities, where Ni≥−0.8125Cu+9.125, and where Ni≤−0.3Cu+8.1 (the values of Cu and Ni being in wt. %).

In another approach, the aluminum alloy is an Al—Cu—Ce alloy, the aluminum alloy comprising at least copper and cerium as alloying elements. In one embodiment, the aluminum, copper, and cerium contents are controlled such that the alloy contains 1.0 to 25.0 wt. % Cu, 1.0 to 18.0 wt. % Ce, the balance being aluminum, optional additions, and unavoidable impurities, where Cu≥−0.8462Ce+12.846, and where Cu≤−0.1361Ce²+1.564Ce+19.673 (the values of Cu and Ce being in wt. %). Such requirements may facilitate production of Al—Cu—Ce alloy products having the fine eutectic-type structure. Intermetallic phases included in these products may include one or more of Al₄Ce, Al₈Cu₄Ce, and Al₂Cu, among others. In a particular embodiment, the aluminum, copper, and cerium contents are controlled such that the alloy contains 1.0 to 25.0 wt. % Cu, 1.0 to 18.0 wt. % Ce, the balance being aluminum, optional additions, and unavoidable impurities, where Cu≥−0.625Ce+12.625, and where Cu≤−0.625Ce+24.625 (the values of Cu and Ce being in wt. %).

In another approach, the aluminum alloy is an Al—Cu—Si alloy, the aluminum alloy comprising at least copper and silicon as alloying elements. In one embodiment, the aluminum, copper, and silicon contents are controlled such that the alloy contains 1.0 to 24.0 wt. % Cu, 0.5 to 25.0 wt. % Si, the balance being aluminum, optional additions, and unavoidable impurities, where Si≥−1.4Cu+16.4, and where Si<−0.0372Cu²−0.2048Cu+24.554 (the values of Cu and Si being in wt. %). Such requirements may facilitate production of Al—Cu—Si alloy products having the fine eutectic-type structure. Intermetallic phases included in these products may include Al₂Cu, among others, and/or particles of silicon (Si). In a particular embodiment, the aluminum, copper, and silicon contents are controlled such that the alloy contains 1.0 to 24.0 wt. % Cu, 0.5 to 25.0 wt. % Si, the balance being aluminum, optional additions, and unavoidable impurities, where Si≥−1.4Cu+16.4, and where Si≤−0.0408Cu²+0.2691Cu+15.281 (the values of Cu and Si being in wt. %).

In another approach, the aluminum alloy is an Al—Ce—Ni alloy, the aluminum alloy comprising at least cerium and nickel as alloying elements. In one embodiment, the aluminum, cerium, and nickel contents are controlled such that the alloy contains 0.5 to 21.0 wt. % Ce, 0.5 to 17.0 wt. % Ni, the balance being aluminum, optional additions, and unavoidable impurities, where Ni≥−0.5833Ce+8.5833, and where Ni≤−0.6316Ce+17.632 (the values of Ce and Ni being in wt. %). Such requirements may facilitate production of Al—Ce—Ni alloy products having the fine eutectic-type structure. Intermetallic phases included in these products may include one or more of Al₃Ni, Al₄Ce, Al₁₀Ni₂Ce and Al₈Ni₄Ce, among others. In a particular embodiment, the aluminum, cerium, and nickel contents are controlled such that the alloy contains 0.5 to 21.0 wt. % Ce, 0.5 to 17.0 wt. % Ni, the balance being aluminum, optional additions, and unavoidable impurities, where Ni≥−0.5833Ce+8.5833, and where Ni≤−0.75Ce+17.75 (the values of Ce and Ni being in wt. %).

In another approach, the aluminum alloy is an Al—Ce—Fe alloy, the aluminum alloy comprising at least cerium and iron as alloying elements. In one embodiment, the aluminum, cerium, and iron contents are controlled such that the alloy contains 0.5 to 21.0 wt. % Ce, 0.5 to 8.0 wt. % Fe, the balance being aluminum, optional additions, and unavoidable impurities, where Fe≥−0.3Ce+4.6, and where Fe≤−0.3062Ce+8.641 (the values of Ce and Fe being in wt. %). Such requirements may facilitate production of Al—Ce—Fe alloy products having the fine eutectic-type structure. Intermetallic phases included in these products may include one or more of Al₃Fe, Al₁₃Fe₄, Al₄Ce, Al₁₀Fe₂Ce, and Al₈Fe₄Ce, among others. In a particular embodiment, the aluminum, cerium, and iron contents are controlled such that the alloy contains 0.5 to 21.0 wt. % Ce, 0.5 to 8.0 wt. % Fe, the balance being aluminum, optional additions, and unavoidable impurities, where Fe≥−0.2857Ce+4.4286, and where Fe≤−0.2Ce+4.2 (the values of Ce and Fe being in wt. %).

In another approach, the aluminum alloy is an Al—Y—Ni alloy, the aluminum alloy comprising at least yttrium and nickel as alloying elements. In one embodiment, the aluminum, yttrium, and nickel contents are controlled such that the alloy contains 0.25 to 20.0 wt. % Y, 1.0 to 17.0 wt. % Ni, the balance being aluminum, optional additions, and unavoidable impurities, where Y≥−1.2857Ni+11.286, and where Y≤−1.1875Ni+21.188 (the values of Y and Ni being in wt. %). Such requirements may facilitate production of Al—Y—Ni alloy products having the fine eutectic-type structure. Intermetallic phases included in these products may include one or more of Al₃Ni, Al₃Y, and Al₁₀Ni₂Y, among others. In a particular embodiment, the aluminum, yttrium, and nickel contents are controlled such that the alloy contains 0.25 to 20.0 wt. % Y, 1.0 to 17.0 wt. % Ni, the balance being aluminum, optional additions, and unavoidable impurities, where Y≥−1.2857Ni+11.286, and where Y≤−0.625Ni+12.125 (the values of Y and Ni being in wt. %).

In another approach, the aluminum alloy is an Al—Y—Mn alloy, the aluminum alloy comprising at least yttrium and manganese as alloying elements. In one embodiment, the aluminum, yttrium, and manganese contents are controlled such that the alloy contains 0.5 to 20.0 wt. % Y, 0.5 to 5.0 wt. % Mn, the balance being aluminum, optional additions, and unavoidable impurities, where Y≥−4.5Mn+11.25, and where Y≤−4.4444Mn+23.222 (the values of Y and Mn being in wt. %). Such requirements may facilitate production of Al—Y—Mn alloy products having the fine eutectic-type structure. Intermetallic phases included in these products may include one or more of Al₆Mn, Al₃Y, and Al₈Mn₄Y, among others. In a particular embodiment, the aluminum, yttrium, and manganese contents are controlled such that the alloy contains 0.5 to 20.0 wt. % Y, 0.5 to 5.0 wt. % Mn, the balance being aluminum, optional additions, and unavoidable impurities, where Y≥−4.5Mn+11.25, and where Y≤−0.7879Mn²+2.1394Mn+10.2 (the values of Y and Mn being in wt. %).

In another approach, the aluminum alloy is an Al—Y—Fe alloy, the aluminum alloy comprising at least yttrium and iron as alloying elements. In one embodiment, the aluminum, yttrium, and iron contents are controlled such that the alloy contains 0.5 to 20.0 wt. % Y, 0.5 to 8.0 wt. % Fe, the balance being aluminum, optional additions, and unavoidable impurities, where Y≥−2.375Fe+11.188, and where Y≤−2.4667Fe+20.233 (the values of Y and Fe being in wt. %). Such requirements may facilitate production of Al—Y—Fe alloy products having the fine eutectic-type structure. Intermetallic phases included in these products may include one or more of Al₃Y, Al₃Fe, Al₁₃Fe₄, Al₁₀Fe₂Y, and Al₈Fe₄Y, among others. In a particular embodiment, the aluminum, yttrium, and iron contents are controlled such that the alloy contains 0.5 to 20.0 wt. % Y, 0.5 to 8.0 wt. % Fe, the balance being, optional additions, aluminum and unavoidable impurities, where Y≥−2.67Fe+11.83, and where Y≤−1.619Fe²+4.0476Fe+9.2143 (the values of Y and Fe being in wt. %).

In another approach, the aluminum alloy is an Al—Cu—Mn alloy, the aluminum alloy comprising at least copper and manganese as alloying elements, and in an amount sufficient to realize a fine eutectic-type structure. Intermetallic phases included in these products may include one or more of Al₂Cu, Al₁₂Mn, Al₆Mn, and Al₂₀Cu₂Mn₃, among others.

In another approach, the aluminum alloy is an Al—Li—Si alloy, the aluminum alloy comprising at least silicon and lithium as alloying elements. In one embodiment, the aluminum, silicon, and lithium contents are controlled such that the alloy contains 1 to 28 wt. % Si, 1 to 5 wt. % Li, the balance being aluminum, optional additions, and unavoidable impurities, where Si≤−5.3Li+32.7, and where Si≥−1.9Li+9.1. Such requirements may facilitate production of silicon and lithium containing aluminum alloy products having the fine eutectic-type structure. Intermetallic phases included in these products may include one or more of Al₃Li, Si-diamond, and AlLiSi among others. In a particular embodiment, the aluminum, silicon, and lithium contents are controlled such that the alloy contains 1 to 28 wt. % Si, 1 to 5 wt. % Li, the balance being aluminum, optional additions, and unavoidable impurities, where Si≤−3Li+19, and where Si≥1.0 (the values of silicon and lithium being in wt. %).

In another approach, the aluminum alloy is an Al—Ni—Si alloy, the aluminum alloy comprising at least silicon and nickel as alloying elements. In one embodiment, the aluminum, silicon, and nickel contents are controlled such that the alloy contains 2 to 27 wt. % Si, 1 to 16 wt. % Ni, the balance being aluminum, optional additions, and unavoidable impurities, where Si≤−0.064Ni²−0.747Ni+29.3, and where Si≥−1.92Ni+15.8. Such requirements may facilitate production of silicon and nickel containing aluminum alloy products having the fine eutectic-type structure. Intermetallic phases included in these products may include one or more of Si-diamond, and Al₃Ni, among others. In a particular embodiment, the aluminum, silicon, and nickel contents are controlled such that the alloy contains 2 to 27 wt. % Si, 1 to 16 wt. % Ni, the balance being aluminum, optional additions, and unavoidable impurities, where Si≤−0.179Ni+19.4, and where Si≥0.51Ni²−4.76Ni+18.9 (the values of silicon and nickel being in wt. %).

In another approach, the aluminum alloy is an Al—Si—Fe alloy, the aluminum alloy comprising at least silicon and iron as alloying elements. In one embodiment, the aluminum, silicon, and iron contents are controlled such that the alloy contains 2 to 28 wt. % Si, 1 to 8 wt. % Fe, the balance being aluminum, optional additions, and unavoidable impurities, where Si≤−2.548Fe+32.2, and where Si≥0.536Fe²−5.96Fe+19.2. Such requirements may facilitate production of silicon and iron containing aluminum alloy products having the fine eutectic-type structure. Intermetallic phases included in these products may include one or more of Si-diamond, and β-AlFeSi, among others. In a particular embodiment, the aluminum, silicon and iron contents are controlled such that the alloy contains 2 to 28 wt. % Si, 1 to 8 wt. % Fe, the balance being aluminum, optional additions, and unavoidable impurities, where Si≤19, and where Si≥−3Fe+16 (the values of silicon and iron being in wt. %).

In another approach, the aluminum alloy is an Al—Si—Mg alloy, the aluminum alloy comprising at least silicon and magnesium as alloying elements. In one embodiment, the aluminum, silicon and magnesium contents are controlled such that the alloy contains 1 to 30 wt. % Si, 1 to 20 wt. % Mg, the balance being aluminum, optional additions, and unavoidable impurities, where Si≤−0.038Mg²−0.11Mg+29.8, and where Si≥0.079Mg²−2.29Mg+18.9. Such requirements may facilitate production of silicon and magnesium containing aluminum alloy products having the fine eutectic-type structure. Intermetallic phases included in these products may include one or more of bcc(B2), and Mg₂Si, among others. The phase, “bcc(B2)” refers to the ordered body-centered cubic (bcc) phase, as opposed to the “bcc(A2)”, disordered bcc phase. In a particular embodiment, the aluminum, silicon and magnesium contents are controlled such that the alloy contains 1 to 30 wt. % Si, 1 to 20 wt. % Mg, the balance being aluminum, optional additions, and unavoidable impurities, where Si≤−0.102Mg²+1.69Mg+17.4, and where Si≥0.09Mg²−2.02Mg+17.7 (the values of silicon and magnesium being in wt. %).

In another approach, the aluminum alloy is an Al—Co—Ni alloy, the aluminum alloy comprising at least cobalt and nickel as alloying elements. In one embodiment, the aluminum, cobalt and nickel contents are controlled such that the alloy contains 1 to 15 wt. % Ni, 1 to 12 wt. % Co, the balance being aluminum, optional additions, and unavoidable impurities, where Ni≤−1.336Co+16.8, and where Ni≥−1.23Co+8.1. Such requirements may facilitate production of cobalt and nickel containing aluminum alloy products having the fine eutectic-type structure. Intermetallic phases included in these products may include one or more of Al₃Ni, and Al₉Co₂, among others. In a particular embodiment, the aluminum, cobalt and nickel contents are controlled such that the alloy contains 1 to 15 wt. % Ni, 1 to 12 wt. % Co, the balance being aluminum, optional additions, and unavoidable impurities, where Ni≤−0.464Co²+1.51Co+9.6, and where Ni≥−1.086Co+6.8 (the values of cobalt and nickel being in wt. %).

In another approach, the aluminum alloy is an Al—Co—Mn alloy, the aluminum alloy comprising at least cobalt and manganese as alloying elements. In one embodiment, the aluminum, cobalt and manganese contents are controlled such that the alloy contains 1 to 4 wt. % Mn, 1 to 10 wt. % Co, the balance being aluminum, optional additions, and unavoidable impurities, where Mn≤−0.376Co+4.67, and where Mn≥−0.257Co+2.4. Such requirements may facilitate production of cobalt and manganese containing aluminum alloy products having the fine eutectic-type structure. Intermetallic phases included in these products may include one or more of Al₆Mn, and Al₉Co₂, among others. In a particular embodiment, the aluminum, cobalt and manganese contents are controlled such that the alloy contains 1 to 4 wt. % Mn, 1 to 10 wt. % Co, the balance being aluminum, optional additions, and unavoidable impurities, where Mn≤−0.4Co+4.73, and where Mn≥−0.257Co+2.4 (the values of cobalt and manganese being in wt. %).

In another approach, the aluminum alloy is an Al—Fe—Ni alloy, the aluminum alloy comprising at least iron and nickel as alloying elements. In one embodiment, the aluminum, iron and nickel contents are controlled such that the alloy contains 1 to 17 wt. % Ni, 1 to 8 wt. % Fe, the balance being aluminum, optional additions, and unavoidable impurities, where Ni≤−2.29Fe+19.3, and where Ni≥−0.917Fe+7.75. Such requirements may facilitate production of iron and nickel containing aluminum alloy products having the fine eutectic-type structure. Intermetallic phases included in these products may include one or more of Al₃Ni, and Al₁₃Fe₄, among others. In a particular embodiment, the aluminum, iron and nickel contents are controlled such that the alloy contains 1 to 17 wt. % Ni, 1 to 8 wt. % Fe, the balance being aluminum, optional additions, and unavoidable impurities, where Ni≤−6Fe+19, and where Ni≥−1Fe+7 (the values of iron and nickel being in wt. %).

In another approach, the aluminum alloy is an Al—Mn—Fe alloy, the aluminum alloy comprising at least manganese and iron as alloying elements. In one embodiment, the aluminum, manganese and iron contents are controlled such that the alloy contains 2 to 5.5 wt. % Mn, 0.5 to 8.5 wt. % Fe, the balance being aluminum, optional additions, and unavoidable impurities, where Mn≤−0.105Fe²+0.546Fe+4.82, and where Mn≥−0.054Fe²+0.153Fe+2.37. Such requirements may facilitate production of manganese and iron containing aluminum alloy products having the fine eutectic-type structure. Intermetallic phases included in these products may include one or more of fcc aluminum, Al₁₃(Fe,Mn)₄, and Al₆Mn, among others. In a particular embodiment, the aluminum, manganese and iron contents are controlled such that the alloy contains 2 to 5.5 wt. % Mn, 0.5 to 8.5 wt. % Fe, the balance being aluminum, optional additions, and unavoidable impurities, where Mn≤−0.643Fe²+1.75Fe+4.07, and where Mn≥−0.179Fe+2.71 (the values of manganese and iron being in wt. %).

In another approach, the aluminum alloy is an Al—Cr—Fe alloy, the aluminum alloy comprising at least chromium and iron as alloying elements. In one embodiment, the aluminum, chromium and iron contents are controlled such that the alloy contains 0.5 to 6.5 wt. % Cr, 0.5 to 6.5 wt. % Fe, the balance being aluminum, optional additions, and unavoidable impurities, where Fe≤−0.1002Cr²−0.0637Cr+6.35, and where Fe≥−0.335Cr²−0.294Cr+6.73. Such requirements may facilitate production of chromium and iron containing aluminum alloy products having the fine eutectic-type structure. Intermetallic phases included in these products may include one or more of Al₁₃Fe₄, and Al₇Cr, among others.

In another approach, the aluminum alloy is an Al—Fe—Mn—Si alloy, the aluminum alloy comprising at least iron, manganese, and silicon as alloying elements. In one embodiment, the aluminum, manganese and iron contents are controlled such that the alloy contains at least 0.5 wt. % Fe, at least 0.5 wt. % Mn, and 4 to 20 wt. % Si, where the amount of (Fe+Mn) is from 2 to 17 wt. %, and where Mn/Fe is from 0.05 to 2, the balance being aluminum, optional additions, and unavoidable impurities. Such requirements may facilitate production of manganese, iron, and silicon containing aluminum alloy products having the fine eutectic-type structure. Intermetallic phases included in these products may include one or more of Al₁₂(Fe,Mn)₃Si, Al₉Fe₂Si₂, among others. In another embodiment, the aluminum, manganese and iron contents are controlled such that the alloy contains at least 0.5 wt. % Fe, at least 0.5 wt. % Mn, and 7 to 15 wt. % Si, where the amount (Fe+Mn) is from 4 to 13 wt. %, and where Mn/Fe is from 0.05 to 2, the balance being aluminum, optional additions, and unavoidable impurities. In yet another embodiment, the aluminum, manganese and iron contents are controlled such that the alloy contains at least 0.5 wt. % Fe, at least 0.5 wt. % Mn, and 10 to 12 wt. % Si, where the amount of (Fe+Mn) is from 8 to 11 wt. %, and where Mn/Fe is from 0.05 to 2, the balance being aluminum, optional additions, and unavoidable impurities.

In another approach, the aluminum alloy is an Al—Cr—Si alloy, the aluminum alloy comprising at least chromium and silicon as alloying elements. In one embodiment, the aluminum, chromium and silicon contents are controlled such that the alloy contains 0.5 to 1.0 wt. % Cr, 14 to 22 wt. % Si, the balance being aluminum, optional additions, and unavoidable impurities, where Si≤−11Cr+27, and where Si≥−2Cr+15.5. Such requirements may facilitate production of chromium and silicon containing aluminum alloy products having the fine eutectic-type structure. Intermetallic phases included in these products may include one or more of Al₇Cr, and/or Si-diamond, among others.

As used herein, “addition” includes grain boundary modifiers, casting aids, and/or grain structure control materials (e.g., ceramic materials, intermetallics, and/or other materials as grain refiners, and/or combinations thereof). In this regard, the above definition of “addition” may be used in the context of additive manufacturing feedstocks (e.g., powder(s); wire(s)), and/or aluminum alloy products (e.g., additively manufactured, ingot, castings, powder metallurgy, among others), unless the context clearly dictates otherwise. Some non-limiting examples of such materials (e.g. referred to as addition, additions, or addition material herein) that may be used in the alloy include: titanium, boron, zirconium, scandium, and hafnium, optionally in elemental form, among others. In some embodiments, at least one of the additions are configured to facilitate the formation of discrete intermetallic particles. In some embodiments, the additions comprise a ceramic, where the ceramic is configured to facilitate the formation of fine grains (e.g., equiaxed grains and/or having an average size of not greater than 20 μm). In some embodiments, the additions comprise an intermetallic, where the intermetallic is configured to facilitate the formation of fine grains.

Some examples of ceramics include oxide materials, boride materials, carbide materials, nitride materials, silicon materials, carbon materials, and/or combinations thereof. Some additional examples of ceramics include metal oxides, metal borides, metal carbides, metal nitrides and/or combinations thereof. Additionally, some non-limiting examples of ceramics include: TiB, TiB₂, TiC, SiC, Al₂O₃, BC, BN, Si₃N₄, Al₄C₃, AlN, their suitable equivalents, and/or combinations thereof.

Without being bound to any particular mechanism or theory, it is believed that such additions may facilitate production of crack-free additively manufactured aluminum alloy products. In one embodiment, the feedstock comprises a sufficient amount of additions to facilitate production of a crack-free additively manufactured aluminum alloy product. The additions, such as grain structure control materials may facilitate, for instance, production of an additively manufactured aluminum alloy product having equiaxed grains in the microstructure. In some embodiments, the aluminum alloy products comprise both equiaxed grains and a fine eutectic-type structure. In this regard, the additions may help facilitate the production of both the equiaxed grains and fine eutectic-type structures. However, excessive additions may decrease the strength of the additively manufactured aluminum alloy product. Thus, in one embodiment, the feedstock comprises a sufficient amount of the additions to facilitate production of a crack-free additively manufactured aluminum alloy product (e.g., via equiaxed grains), but the amount of additions in the aluminum alloy product is limited so that the additively manufactured aluminum alloy product retains its strength (e.g., tensile yield strength (TYS) and/or ultimate tensile strength (UTS)). In some embodiments, the amount of additions may be limited such that the strength of the aluminum alloy product substantially corresponds to its strength without the additions (e.g., within 5 ksi; within 1-4 ksi). In some embodiments, the amount of additions may be limited such that the strength of the aluminum alloy product substantially corresponds to its strength without the addition (e.g., within 5%).

In some embodiments, the additions comprise at least one grain refiner. In some embodiments, the additions comprise at least one grainer refiner, where the at least one grain refiner is sufficient to facilitate production of small grains.

In some embodiments, the feedstock or product comprises up to 5 wt. % of additions. In one embodiment, the feedstock or product comprises at least 0.01 wt. % of the additions. In another embodiment, the feedstock or product comprises at least 0.05 wt. % of the additions. In yet another embodiment, the feedstock or product comprises at least 0.08 wt. % of the additions. In another embodiment, the feedstock or product comprises at least 0.1 wt. % of the additions. In yet another embodiment, the feedstock or product comprises at least 0.5 wt. % of the additions. In another embodiment, the feedstock or product comprises at least 0.8 wt. % of the additions. In one embodiment, the feedstock or product comprises not greater than 4.5 wt. % of the additions. In another embodiment, the feedstock or product comprises not greater than 4.0 wt. % of the additions. In yet another embodiment, the feedstock or product comprises not greater than 3.5 wt. % of the additions. In another embodiment, the feedstock or product comprises not greater than 3.0 wt. % of the additions. In yet another embodiment, the feedstock or product comprises not greater than 2.5 wt. % of the additions. In another embodiment, the feedstock or product comprises not greater than 2.0 wt. % of the additions. In yet another embodiment, the feedstock or product comprises not greater than 1.5 wt. % of the additions. In another embodiment, the feedstock or product comprises not greater than 1.25 wt. % of the additions. In yet another embodiment, the feedstock or product comprises not greater than 1.0 wt. % of the additions. In one embodiment, the feedstock or product or product comprises 0.01 to 5 wt. % of the additions. In another embodiment, the feedstock or product or product comprises 0.1 to 5 wt. % of the additions. In yet another embodiment, the feedstock or product or product comprises 0.01 to 1 wt. % of the additions. In another embodiment, the feedstock or product or product comprises 0.1 to 1 wt. % of the additions. In yet another embodiment, the feedstock or product or product comprises 0.5 to 3 wt. % of the additions. In another embodiment, the feedstock or product or product comprises 1 to 3 wt. % of the additions. In some of these embodiments, the additions comprise at least one ceramic material, wherein at least one ceramic material is TiB₂.

As used herein, “equiaxed grains” means grains having an average aspect ratio of not greater than 1.5 to 1 as measured in the XY, YZ, and XZ planes as determined by the “Heyn Lineal Intercept Procedure” method described in ASTM standard E112-13, entitled, “Standard Test Methods for Determining Average Grain Size”. Additively manufactured products that comprise equiaxed grains may realize, for instance, improved ductility and/or strength. In this regard, equiaxed grains that realize an average grain size of not greater than 20 microns may help facilitate the realization of improved ductility and/or strength, among others. In one embodiment, an additively manufactured product comprises equiaxed grains, wherein the average grain size is of from 0.5 to 20 microns. In one embodiment, an additively manufactured product comprises equiaxed grains, wherein the average grain size is not greater than 10 microns. In another embodiment, an additively manufactured product comprises equiaxed grains, wherein the average grain size is not greater than 6 microns. In yet another embodiment, an additively manufactured product comprises equiaxed grains, wherein the average grain size is not greater than 4 microns.

The characteristics of the aluminum alloy products described herein (e.g., fine eutectic-type structures, equiaxed grains, etc.) may prevent, reduce, and/or eliminate defects that may occur during additive manufacturing. For instance, fine equiaxed grains (e.g., having an average grain size of not greater than 20 μm) may facilitate reduced cracking of additively manufactured products. In some embodiments, the additively manufactured products are crack-free.

As used herein, “crack-free additively manufactured product” means an additively manufactured product that is sufficiently free of cracks such that it can be used for its intended, end-use purpose. The determination of whether an additively manufactured product is “crack-free” may be made by any suitable method, such as, by visual inspection, dye penetrant inspection, and/or by non-destructive test methods. In some embodiments, the non-destructive test method is a computed topography scan (“CT scan”) inspection (e.g., by measuring density differences within the product). In one embodiment, an additively manufactured product is determined to be crack-free by visual inspection. In another embodiment, an additively manufactured product is determined to be crack-free by dye penetrant inspection. In yet another embodiment, an additively manufactured product is determined to be crack-free by CT scan inspection. In another embodiment, an additively manufactured product is determined to be crack-free during the additive manufacturing process, wherein in situ monitoring of the additive manufacturing build is employed.

Powder Metallurgy

While the above disclosure generally relates to aluminum alloy products produced via additive manufacturing, in some embodiments, one or more of the above aluminum alloy compositions may also find utility in powder metallurgy methods. For instance, an aluminum alloy powder comprising the fine eutectic-type structure may be used to produce a powder metallurgy product. In this regard, the powder may be produced by suitable methods, such as by plasma atomization, gas atomization, or impingement of molten metal (e.g., solidification of an impinging molten metal droplet on a cold substrate).

The aluminum alloy powders comprising the fine eutectic-type structure may be compacted into final or near-final product form. For instance, the powder may be compacted via low pressure methods and/or via pressurized methods. In this regard, low pressure methods such as, loose powder sintering, slip casting, slurry casting, tape casting, or vibratory compaction may be used. In another aspect, pressurized methods may be used to realize the compaction by methods such as, for instance, die compaction, cold/hot isostatic pressing, and/or sintering. In some embodiments, one or more of the above aluminum alloy compositions may also find utility in powder metallurgy methods where powders are cold isostatically pressed to a green compact (e.g. sufficiently densified to enable further hot pressing, e.g. greater than 70% theoretical density), then vacuum hot pressed or hot isostatically pressed to form a substantially dense billet substantially corresponding to near theoretical density (e.g. above 99% theoretical density).

Such powder metallurgy methods may facilitate production of crack-free final or near-final products. In any event, the crack-free product may be further processed to obtain a wrought final product. This further processing may include any combination of thermal treating and/or working steps. In this regard, the crack-free product may be further processed via hot or cold rolling, extruding, forging, and/or combinations thereof.

### Ingot, Castings and Wrought Alloy Products

While the above disclosure generally relates to aluminum alloy products produced via additive manufacturing, in some embodiments, one or more of the above aluminum alloy compositions may also find utility as ingot, casting alloys and/or wrought alloys. Thus, the present patent application also relates to ingot, casting alloys and wrought alloys made from the above-described aluminum alloy compositions. Indeed, the new products described herein may be produced by any other processes capable of generating solidification rates sufficient to impart the fine eutectic-type structure. For instance, some continuous casting processes, such as those described in U.S. Pat. No. 7,182,825, may be capable of sufficiently high solidification rates, and the disclosure of this patent is incorporated herein by reference in its entirety.

Further, while the thermally treating step (400) may be useful in producing discrete intermetallic particles, this thermally treating step is expressly optional, and the products described herein may be sold or utilized without employing the thermally treating step.

### Product Applications

The aluminum products described herein may be used in a variety of product applications. In one embodiment, the aluminum products are utilized in an elevated temperature application, such as in an aerospace (e.g. engines or structures), automotive vehicle (e.g. piston, valve, among others), defense, electronics (e.g. consumer electronics) or space applications. In one embodiment, an aluminum product is utilized as an engine component in an aerospace vehicle (e.g., in the form of a blade, such as a compressor blade incorporated into the engine). In another embodiment, the aluminum product is used as a heat exchanger for the engine of the aerospace vehicle. The aerospace vehicle including the engine component/heat exchanger may subsequently be operated. In one embodiment, an aluminum product is an automotive engine component. The automotive vehicle including the engine component may subsequently be operated. For instance, an aluminum product may be used as a turbo charger component (e.g., a compressor wheel of a turbo charger, where elevated temperatures may be realized due to recycling engine exhaust back through the turbo charger), and the automotive vehicle including the turbo charger component may be operated. In another embodiment, an aluminum product may be used as a blade in a land based (stationary) turbine for electrical power generation, and the land based turbine included the aluminum product may be operated to facilitate electrical power generation.

Finally, while various embodiments of the new technology described herein have been described in detail, it is apparent that modifications and adaptations of those embodiments will occur to those skilled in the art. However, it is to be expressly understood that such modifications and adaptations are within the spirit and scope of the presently disclosed technology.

### BRIEF DESCRIPTION OF THE DRAWINGS

FIG. 1 shows an embodiment for producing an aluminum alloy product having a fine eutectic-type structure, in accordance with the present disclosure.

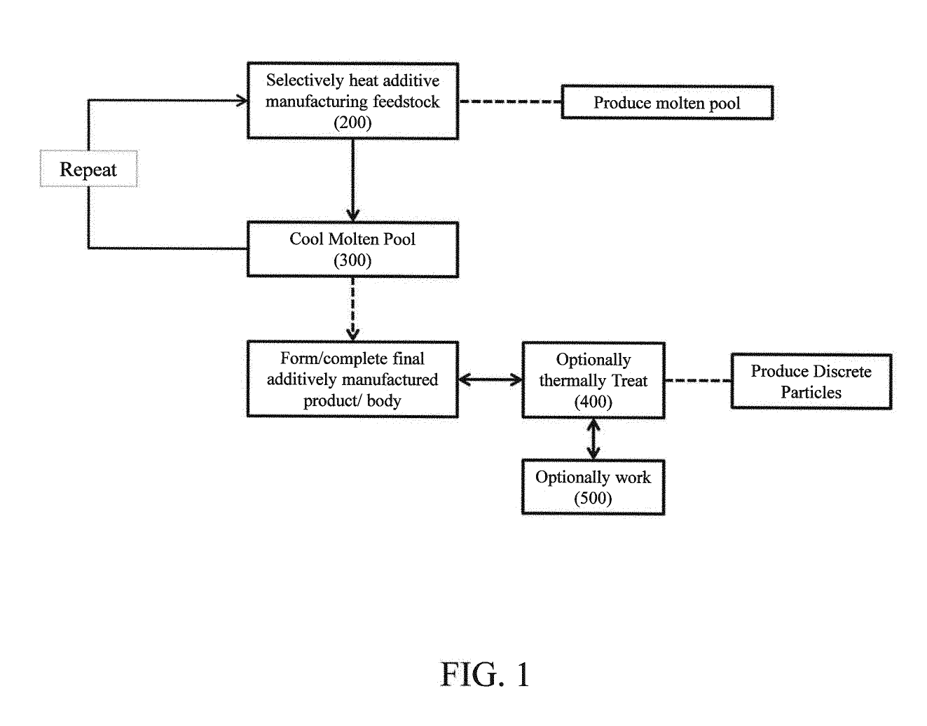

FIG. 2 shows a micrograph of an additively manufactured Al—Ni—Mn alloy (5.3 wt. % Ni, 1.3 wt. % Mn) that illustrates examples of the types of fine eutectic-type structures disclosed herein, including visual representations of lamellar, wavy, and microcellular structures obtained from an image of this sample. Without wishing to be bound by a particular mechanism or theory, each of lamellar, wavy, and microcellular structures are examples of fine eutectic-type structures and each may be found individually, or in combination, in one or more of the embodiments of the present disclosure.

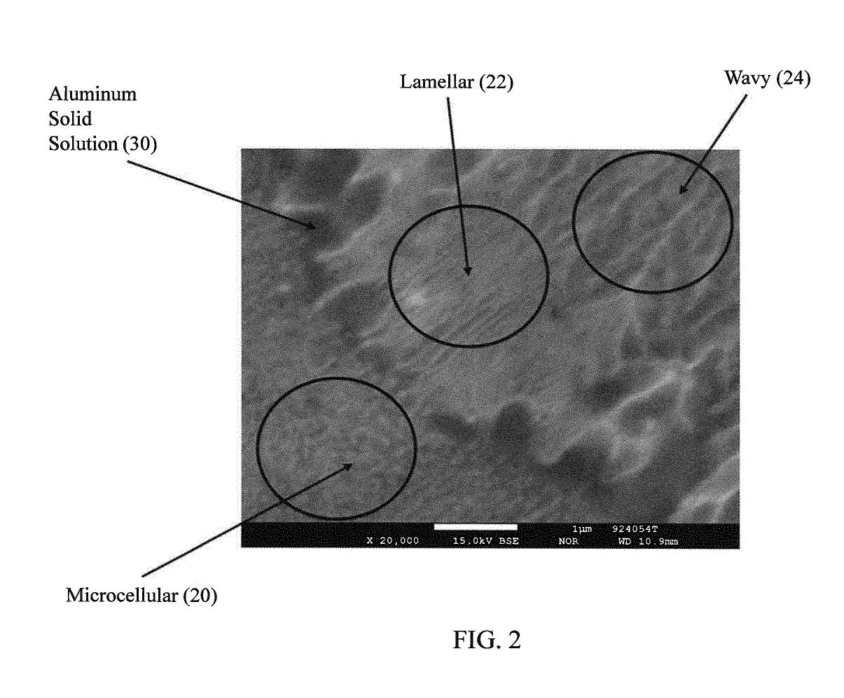

FIG. 3 shows a micrograph of an additively manufactured Al—Ni—Mn alloy (5.3 wt. % Ni, 1.3 wt. % Mn) after exposure to a temperature of 600° F. for 100 hours. As depicted herein in this sample, discrete particles are dispersed in an aluminum solid solution matrix. As shown by the two discrete particles circled, the corresponding size of the discrete particles may vary in accordance with the various embodiments of present disclosure.

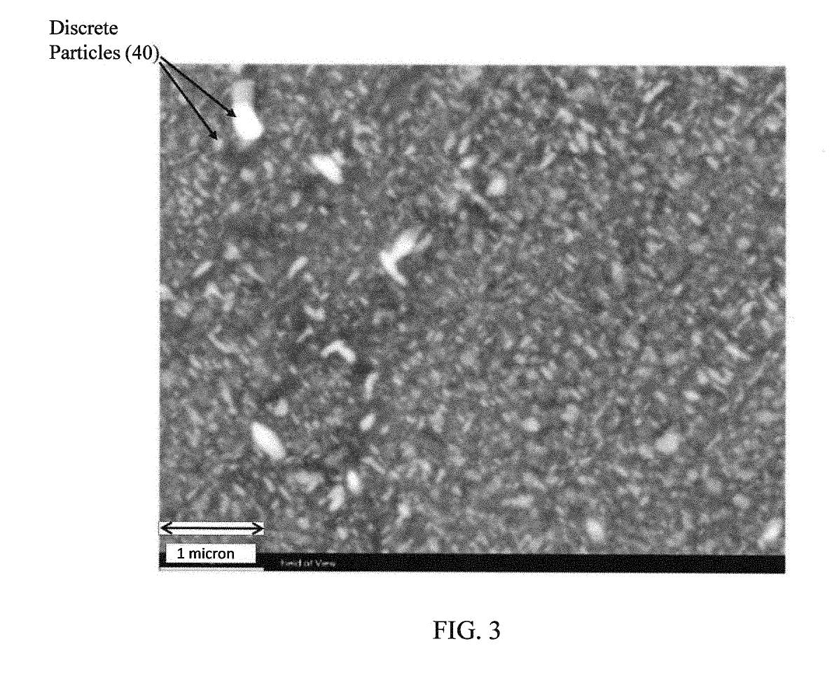

FIG. 4 shows an SEM micrograph of an additively manufactured coupon of Alloy 1 from Example 1 that provides an illustrative example of a fine eutectic-type structure having predominately microcellular structures, and shows ceramic TiB₂ particles within the microstructure, in accordance with various embodiments of the present disclosure.

FIG. 5a shows an SEM micrograph of an additively manufactured coupon of Alloy 1 from Example 1 that provides an illustrative example of regions of microcellular and lamellar structures in a sample, in accordance with various embodiments of the present disclosure.

FIG. 5b shows an SEM micrograph of an additively manufactured coupon of Alloy 1 from Example 1 that further illustrates the interface of lamellar and microcellular structures shown in FIG. 5a.

FIG. 6a shows an EBSD micrograph of an additively manufactured product of Alloy 1 from Example 1 that illustrates the grains and grain boundaries of the microstructure. As shown by the EBSD micrograph, and quantified by the grain size distribution in FIG. 6b, the additively manufactured product realized an average grain size of about 2 microns, in accordance with various embodiments of the present disclosure.

FIG. 6b shows a grain size distribution of the Alloy 1 EBSD micrograph given in FIG. 6a.

FIG. 7 shows an SEM micrograph of a solidified coupon of Alloy 2 of Example 2 that illustrates a microcellular structures, and a large amount of discrete intermetallic particles in the microstructure, in accordance with various embodiments of the present disclosure.

### DETAILED DESCRIPTION

### EXAMPLE 1

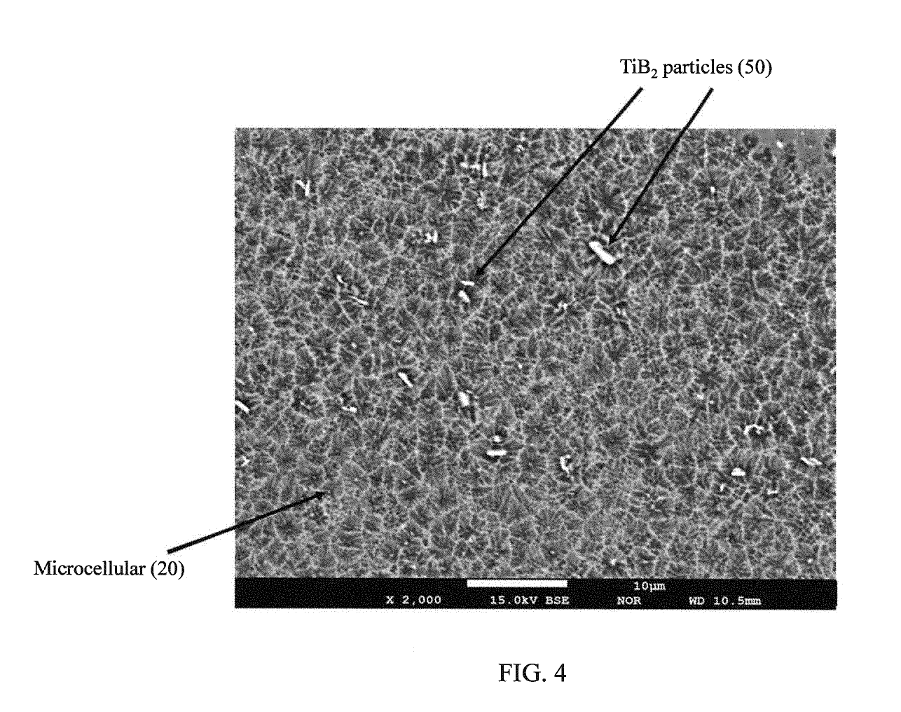

An additively manufactured product made of an Al—Ni—Mn alloy (“Alloy 1”) was produced using a laser powder bed additive manufacturing apparatus. The target composition of Alloy 1 was 6 wt. % Ni, 2.8 wt. % Mn, and 1.7 wt. % of TiB₂, the balance being aluminum. Various samples of the Alloy 1 coupon were prepared for microstructural analysis in the as-solidified condition (i.e., absent of any thermal treatment), the micrographs of which are shown in FIGS. 4, 5a, 5b, and 6a.

A micrograph of a region of Alloy 1 was taken at 2,000× magnification using a scanning electron microscope (“SEM”), and is shown in FIG. 4. As shown in FIG. 4, the additively manufactured Alloy 1 microstructure is predominately comprised of microcellular (20) structures. Furthermore, FIG. 4 shows ceramic TiB₂ particles of generally less than 5 microns in size in the Alloy 1 microstructure.

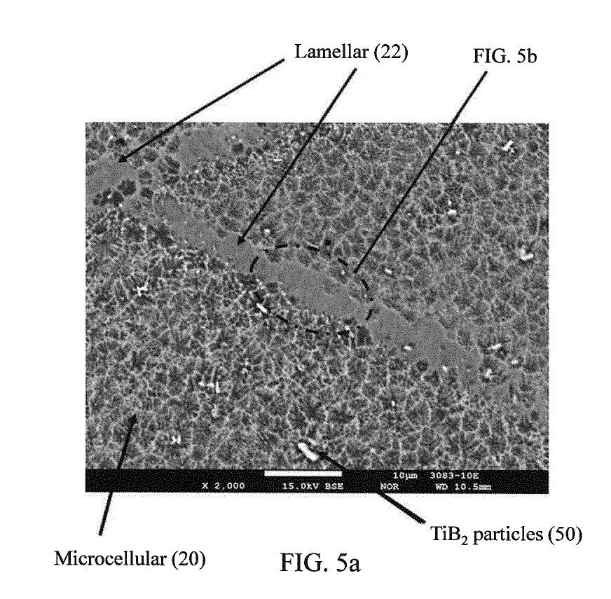

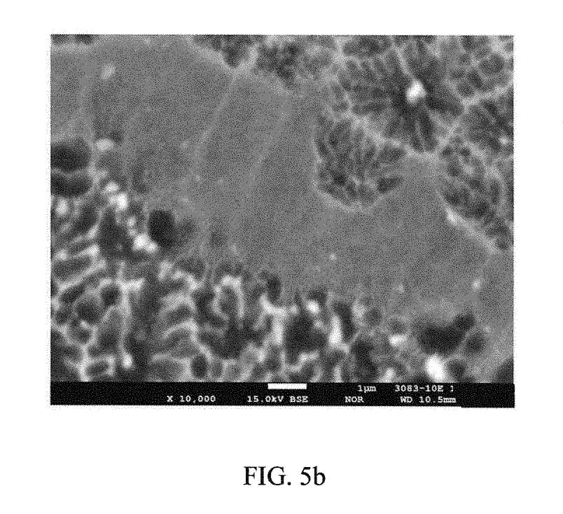

SEM micrographs of another region of the Alloy 1 additively manufactured product were taken at 2,000× and 10,000× magnification, and are shown in FIGS. 5a and 5b, respectively. The region of Alloy 1 shown in FIG. 5a shows both microcellular structures (20) and lamellar structures (22) within the alloy's microstructure. Further, the encircled region in FIG. 5a shows an interface between lamellar structures (22) and microcellular structures (20). The encircled interface is more closely illustrated in FIG. 5b at 10,000× magnification. In this regard, the interface between the lamellar structures (22) is thought to have formed at molten pool boundaries formed during the additive manufacturing process. Furthermore, similar to FIG. 4, FIG. 5a shows TiB₂ particles (50) of generally less than 5 microns in size.

As noted above, the microstructure of the Al—Ni—Mn alloy generally shows microcellular (20) and lamellar (22) structures. However, other eutectic structures may be realized. In this regard, the cell walls and/or lamella of eutectic structures shown in FIGS. 4-5b generally consist of intermetallic phases (e.g., Al₆Mn, Al₁₂Mn, and Al₃Ni, and/or other Al—Ni—Mn compounds) dispersed in an aluminum solid solution phase. In this aspect, the intermetallic phases may facilitate strength retention of the alloy at elevated temperatures. Furthermore, due to the composition and method of production, the Alloy 1 aluminum phase may be a supersaturated solid solution.

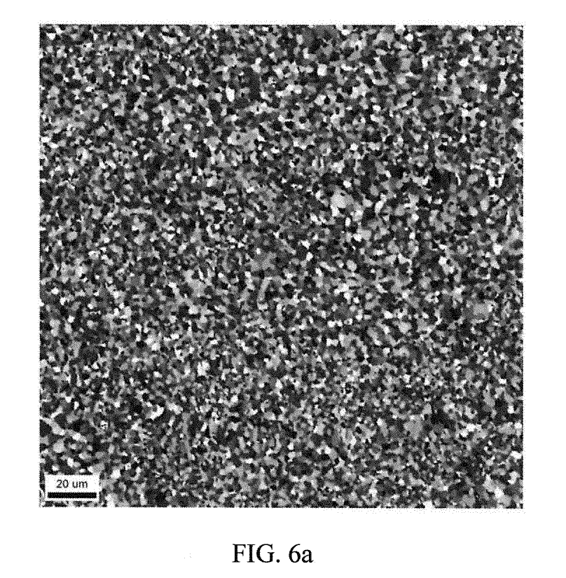

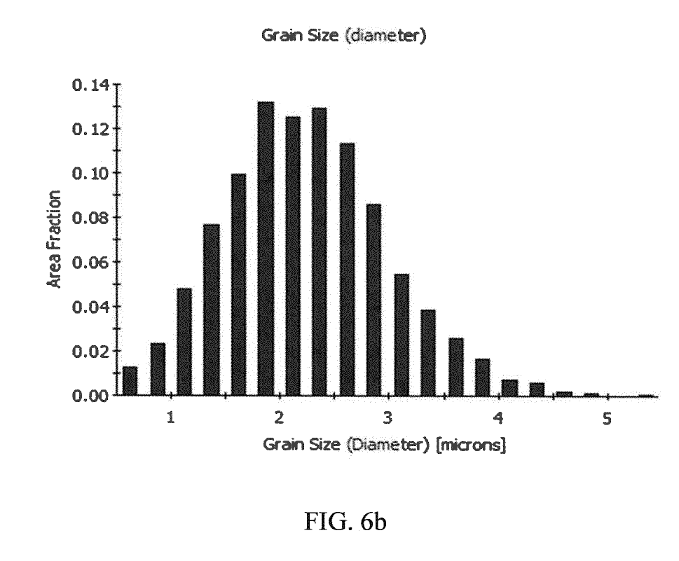

Alloy 1 was prepared for electron backscattered diffraction (“EBSD”) analysis. An image showing the grains and grain boundaries of the Alloy 1 microstructure from the EBSD analysis is shown in FIG. 6a. Furthermore, the grain size distribution resulting from the EBSD analysis is shown in FIG. 6b. In this regard, the Alloy 1 coupon realized a microstructure having equiaxed grains and an average grain size of approximately 2 microns.

### EXAMPLE 2

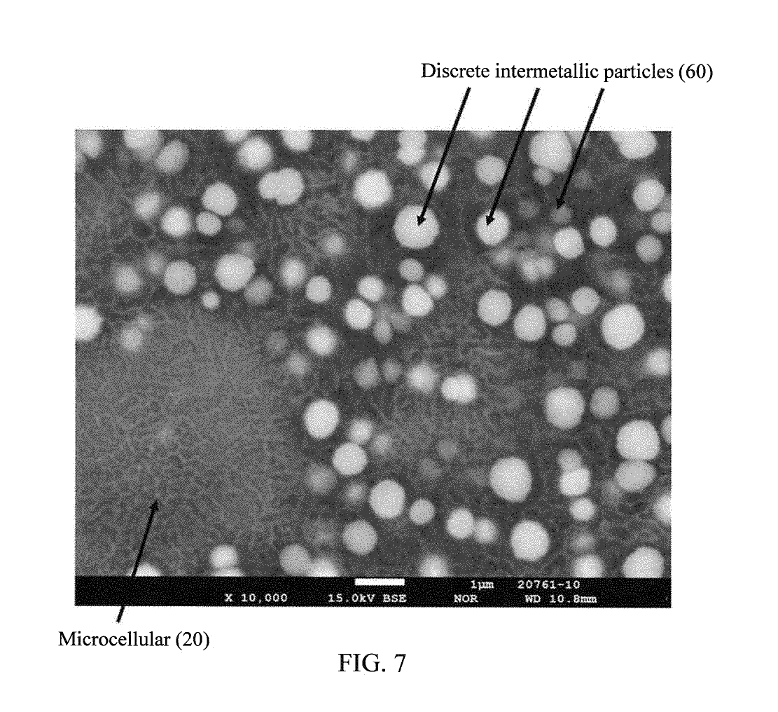

A coupon of an Al—Fe—Mn—Si alloy (“Alloy 2”) was subjected to rapid solidification to simulate a laser powder bed additive manufacturing process. The target composition of Alloy 2 was 5 wt. % Fe, 5 wt. % Mn, and 12 wt. % Si, the balance being aluminum. Following solidification of the Alloy 2 coupon, a sample was prepared for microstructural analysis in the as-solidified condition (i.e., absent of any thermal treatment). In this regard, an SEM micrograph of Alloy 2 at 10,000× magnification is shown in FIG. 7. As shown in FIG. 7, the Alloy 2 microstructure is predominately comprised of microcellular (20) structures. However, other eutectic structures may be realized. Furthermore, the alloy microstructure shows a large volume fraction of discrete intermetallic particles (60), that may be comprised of intermetallic phases, such as Al₁₂(Fe,Mn)₃Si and/or Al₉Fe₂Si₂, among others. Additionally, the cell walls shown in FIG. 7 generally consist of Al₁₂(Fe,Mn)₃Si and/or Al₉Fe₂Si₂ intermetallic phases, among others. In this regard, the intermetallic phases (i.e., cell walls and/or discrete intermetallic particles) may facilitate strength retention of the alloy at elevated temperatures. Lastly, the Alloy 2 aluminum phase may be a supersaturated solid solution.

What is claimed is:

1. A method for producing an aluminum alloy product having a fine eutectic-type structure, the method comprising:
(a) selectively heating at least a portion of an additive manufacturing feedstock to a temperature above a liquidus temperature of the additive manufacturing feedstock, thereby forming a molten pool;
(b) cooling the molten pool, thereby forming a solidified mass, wherein the solidified mass comprises a fine eutectic-type structure;
(c) repeating steps (a)-(b), thereby producing a final additively manufactured product, wherein the final additively manufactured product comprises the fine eutectic-type structure; and
wherein the final additively manufactured product is crack-free.

2. The method of claim 1, wherein the additive manufacturing feedstock comprises aluminum and at least one other alloying element.

3. The method of claim 2, wherein the additive manufacturing feedstock comprises additions.

4. The method of claim 3, wherein at least one of the additions is configured to facilitate grain refinement.

5. The method of claim 4, wherein the additions comprise at least one grain refiner.

6. The method of claim 5, wherein the at least one grain refiner is sufficient to facilitate the nucleation of aluminum alloy grains.

7. The method of claim 3, wherein the final additively manufactured product comprises from 0.01 to 5 wt. % of the additions.

8. The method of claim 7, wherein the additions comprise TiB₂.

9. The method of claim 1, wherein the aluminum alloy product has a non-equilibrium freezing range of not greater than 680° F.

10. The method of claim 1, comprising:
thermally treating the final additively manufactured product, wherein the thermally treating is sufficient to create discrete particles from the fine eutectic-type structure;
wherein the discrete particles are dispersed in an aluminum matrix;
wherein the discrete particles comprise intermetallic phases of the fine eutectic-type structure.

11. The method of claim 10, wherein the final additively manufactured product comprises from 5 to 35 vol. % of the discrete particles.

12. The method of claim 11, wherein an average size of the discrete particles is not greater than 1 micron.

13. The method of claim 1, wherein the fine eutectic-type structure comprises cellular structures having a cell size of not greater than 1 micron.

14. The method of claim 13, wherein the cellular structures having a cell size of at least 10 nanometers.

15. The method of claim 1, wherein the final additively manufactured product comprises equiaxed grains, wherein the equiaxed grains realize an average grain size of not greater than 20 microns.

16. The method of claim 1, wherein the aluminum alloy product is an Al—Ni—Mn alloy product comprising 0.5 to 15.5 wt. % Ni, from 0.5 to 5.0 wt. % Mn, the balance being aluminum, optional additions, and unavoidable impurities, wherein Ni≥−2.75Mn+7.375, and wherein Ni≤−3.44Mn+17.22.

17. The method of claim 1, wherein the aluminum alloy product is an Al—Cu—Ni alloy product comprising 1.0 to 22.0 wt. % Cu, 1.0 to 16.0 wt. % Ni, the balance being aluminum, optional additions, and unavoidable impurities, wherein Ni≥−0.78Cu+8.78, and wherein Ni≤−0.738Cu+17.24.

18. The method of claim 1, wherein the aluminum alloy product is an Al—Cu—Ce alloy product comprising 1.0 to 25.0 wt. % Cu, 1.0 to 18.0 wt. % Ce, the balance being aluminum, optional additions, and unavoidable impurities, wherein Cu≥−0.8462Ce+12.846, and wherein Cu≤−0.1361Ce²+1.564Ce+19.673.

19. The method of claim 1, wherein the aluminum alloy product is an Al—Cu—Si alloy product comprising 1.0 to 24.0 wt. % Cu, 0.5 to 25.0 wt. % Si, the balance being aluminum, optional additions, and unavoidable impurities, wherein Si≥−1.4Cu+16.4, and wherein Si≤−0.0372Cu²−0.2048Cu+24.554.

20. The method of claim 1, wherein the aluminum alloy product is an Al—Ce—Ni alloy product comprising 0.5 to 21.0 wt. % Ce, 0.5 to 17.0 wt. % Ni, the balance being aluminum, optional additions, and unavoidable impurities, wherein Ni≥−0.5833Ce+8.5833, and wherein Ni≤−0.6316Ce+17.632.
